(19) United States
(12) Patent Application Publication
(10) Pub. No.: US 2010/0000017 A1
(43) Pub. Date: Jan. 7, 2010

(54) Lift System with Kinematically Dissimilar Lift Mechanisms

(76) Inventors: Dennis P. Laloge, Batesville, IN (US); John D. Christie, Batesville, IN (US); Maurice V. Cancasci, JR., Mason, OH (US)

Correspondence Address: HILL-ROM SERVICES, INC., Legal Dept., Mail Code K04, 1069 State Road 46 East, BATESVILLE, IN, 47006, US

(21) Appl. No.: 12/168,466

(22) Filed: Jul. 7, 2008

(51) Int. Cl. A61G 7/012

(52) U.S. Cl. 5/611

(57) ABSTRACT

A lift system for a bed frame 18 includes multiple lift mechanisms (e.g. M_{H}, M_{F}) at least one of which is kinematically dissimilar to the other lift mechanisms. A dedicated actuator A_{H}, A_{F} drives each of the multiple lift mechanisms. Each actuator includes a motor m_{H}, m_{F} responsive to a voltage V_{H}, V_{F}. During operation, the voltage supplied to each motor is regulated to effect a change in elevation of the frame 18 while concurrently effecting a prescribed change in an angular orientation of the frame.

### TECHNICAL FIELD

This subject matter of this application relates to lift systems for frames such as those used on height adjustable beds.

### BACKGROUND

Lift systems for height adjustable frames, such as the frames used on hospital beds, include lift mechanisms allowing the height adjustable frame to be raised or lowered. A typical lift system includes two lift mechanisms, each comprising a set of links extending between a fixed-height base frame and the height adjustable frame. Typically, the mechanisms are arranged symmetrically and are at least partly longitudinally offset from each other so that one mechanism governs the elevation of a head end of the frame and the other mechanism governs the elevation of a foot end of the frame. Each lift mechanism is connected to a piston projecting from a motor driven linear actuator. During operation the motors extend or retract the pistons, thereby operating the lift mechanisms and changing the elevation of the height adjustable frame. The lift mechanisms are kinematically similar, i.e. they have the same geometric input-output relationship. Equal voltages are applied to each of the motors to raise or lower the height adjustable frame without changing its angular orientation. Unequal voltages are applied to the motors to raise or lower one end of the frame (e.g. the foot end) faster than the other end to change the angular orientation of the frame.

Although the above described kinematically similar mechanisms are often satisfactory, it may be desirable or necessary to employ kinematically dissimilar mechanisms due to space constraints or to achieve more elaborate motions of the frame. It is known to operate such kinematically dissimilar mechanisms with hydraulic actuation systems. Such hydraulic systems are designed and operated to account for the dissimilar kinematics. Unfortunately, hydraulic systems can be heavy, expensive and noisy during operation, and always present some risk of hydraulic fluid leaks.

### SUMMARY

A lift system for a bed frame comprises multiple lift mechanisms, at least one of which is kinematically dissimilar to the other lift mechanisms, and a dedicated actuator for driving each of the multiple lift mechanisms. Each actuator includes a motor that responds to a voltage. The voltage supplied to each motor is regulated to change the elevation of the frame while concurrently effecting a prescribed change in the angular orientation of the frame.

### BRIEF DESCRIPTION OF THE DRAWINGS

FIG. 1 is a schematic, side elevation view of an adjustable height bed showing a lift system with a pair of kinematically dissimilar lift mechanisms and their associated actuators.

FIGS. 1A and 1B are views of example user interfaces for a lift system as described herein.

FIG. 2 is a view illustrating the notion of momentarily numerically equal but generally unequal drive voltages.

FIG. 3 is a view illustrating the notion of drive voltages that are generally unequal but which may be substantially numerically equal for a sustained period of time to achieve a particular combination of a prescribed change in elevation and a prescribed change in angular orientation.

FIG. 4 is a view similar to FIG. 1 showing a conventional bed with its height adjustable frame 18′ shown at two different elevations.

FIG. 5 is a view similar to FIG. 1 showing a lift system with position sensors and a controller.

FIG. 6 is a more generic depiction of the bed shown in FIG. 1.

FIG. 7 is a more generic depiction of the bed shown in FIG. 5.

### DETAILED DESCRIPTION

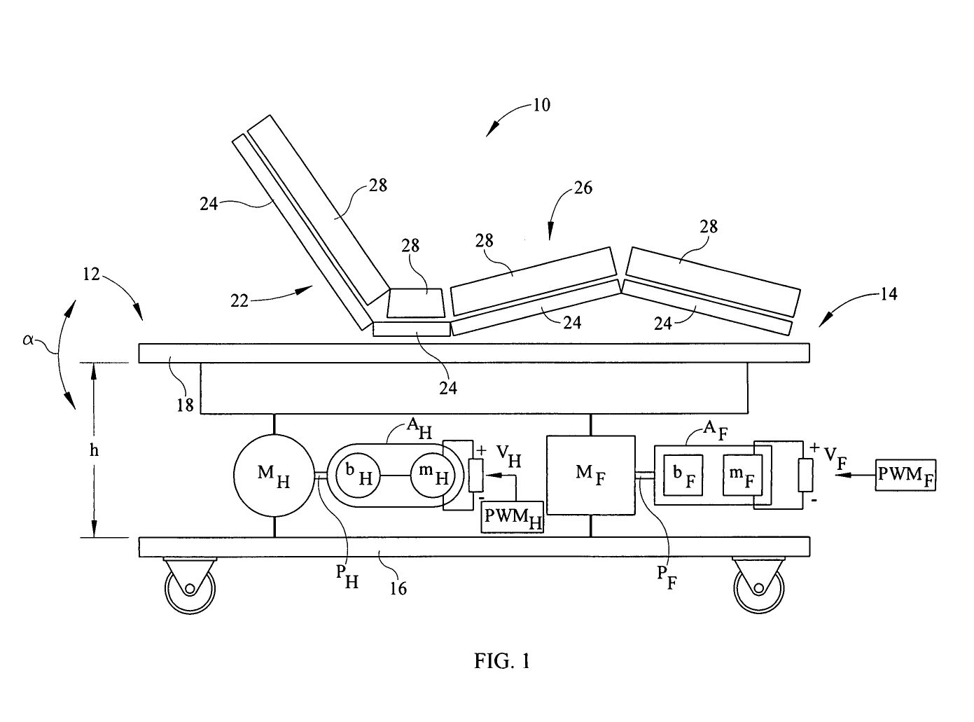

Referring to FIG. 1, an adjustable bed 10, such as a hospital bed, extends longitudinally from a head end 12 to a foot end 14 and also extends laterally (perpendicular to the plane of the illustration) between a right flank (visible in the illustration) and a left flank (not visible). The bed includes a base frame 16 and a height adjustable frame 18. A pair of lift mechanisms M_{H}, M_{F} connect the base frame to the height adjustable frame and govern the elevation h of the height adjustable frame relative to the base frame. The mechanisms are depicted schematically because a wide variety of constructions will operate satisfactorily in the context of the lift system described herein. The lift mechanisms are kinematically dissimilar, i.e. they have different input-output relationships. The height adjustable frame 18 supports a variable profile deck 22, which includes multiple segments 24. The angular orientation and/or longitudinal position of at least some of the segments 24 are adjustable by way of actuators and associated mechanisms, not shown, to conform the profile of the bed to the needs of the occupant thereof. A mattress 26, which may comprise multiple individual cushions 28, as shown, or which may be longitudinally non-segmented, rests on the variable profile deck.

Head end lift mechanism M_{H} governs the elevation of the head end 12 of the height adjustable frame 18. Similarly, foot end lift mechanism M_{F} governs the elevation of the foot end 14 of the height adjustable frame. Each mechanism may adjust the elevation at the same rate, resulting in no accompanying change in the angular orientation α of the height adjustable frame 18.

Alternatively, the mechanisms may adjust the elevations of the head end and the foot end at different rates so that the orientation α changes.

A dedicated linear actuator A_{H}, A_{F} is provided to drive each of the mechanisms M_{H}, M_{F}. The schematically illustrated actuators each comprise an electric motor m_{H}, m_{F} responsive to a voltage source V_{H}, V_{F}, and a ballscrew mechanism b_{H}, b_{F} driven by the motor to effect extension or retraction of a piston P_{H}, P_{F}. However, other types of actuators may also be used. These other types of actuators include motors whose a rotary output drives the lift mechanism directly rather than first being converted to a linear output. Each actuator may be the same model actuator or they may be different models. However because the lift mechanisms are kinematically dissimilar the actuators will also differ from each other in many practical applications. For example, the relationship between the change in actuator stroke (i.e. the linear extension of pistons P_{H}, P_{F}) and motor revolutions may not be the same in actuators A_{H}, A_{F}.

FIGS. 1A and 1B each show examples of relevant portions of a user interface for controlling the lift system described herein. FIG. 1A shows an interface with buttons 32, 34 for commanding the height h and buttons 36, 38 for commanding the angular orientation α of the height adjustable frame 18. The interface of FIG. 1A requires a sustained input from the user i.e. the commanded motion of frame 18 ceases if the user releases pressure on the button. FIG. 1B shows an alternative interface comprising a height command button 40 and an associated display 42, an angular orientation command button 44 and an associated display 46, a “GO” button 48, a “STOP” button 50 and a numeric keypad 52. To use this system a user presses the height button 40 and then uses the keypad 52 to enter a desired height. The user presses the angle button 44 and then uses the keypad to enter a desired angular orientation. Once the user is satisfied with the commanded height and/or angle as indicated in the displays 42, 46, the user then presses the “GO” button to command the lift system to adjust the frame 18 to the commanded height and/or angle. The stop button 50 allows the user to interrupt the movement of the frame. It is emphasized that the described user interfaces are merely examples, and that many other interface configurations are applicable.

In operation, a drive voltage V_{H}, V_{F} is applied to each of the motors m_{H}, m_{F}. Because mechanism M_{H} is kinematically dissimilar from mechanism M_{F}, the application of equal voltages would result in not only a change in elevation, but also in a non-selectable change in angular orientation. Therefore, voltages V_{H}, V_{F} generally differ from each other. The different voltages compensate for the kinematic dissimilarity of mechanisms M_{H}, M_{F} so that the pistons P_{H}, P_{F} extend (or retract) at different rates. Specifically, the voltage supplied to each motor is regulated to effect a change in elevation of the frame while concurrently effecting a prescribed change in its angular orientation α. The voltage may be regulated by using pulse width modulation as signified by the diagram elements labeled PWM_{H} and PWM_{F} in FIG. 1, or may be regulated using other available techniques. In some circumstances, the prescribed change in angular orientation is zero, i.e. the initial position of the height adjustable frame (which may or may not be horizontal) and its final position are parallel to each other. In other circumstances, it may be desirable, during a change in elevation, to also effect a non-zero change in angular orientation. This may be readily accomplished by the use of appropriate voltages V_{H}, V_{F}.

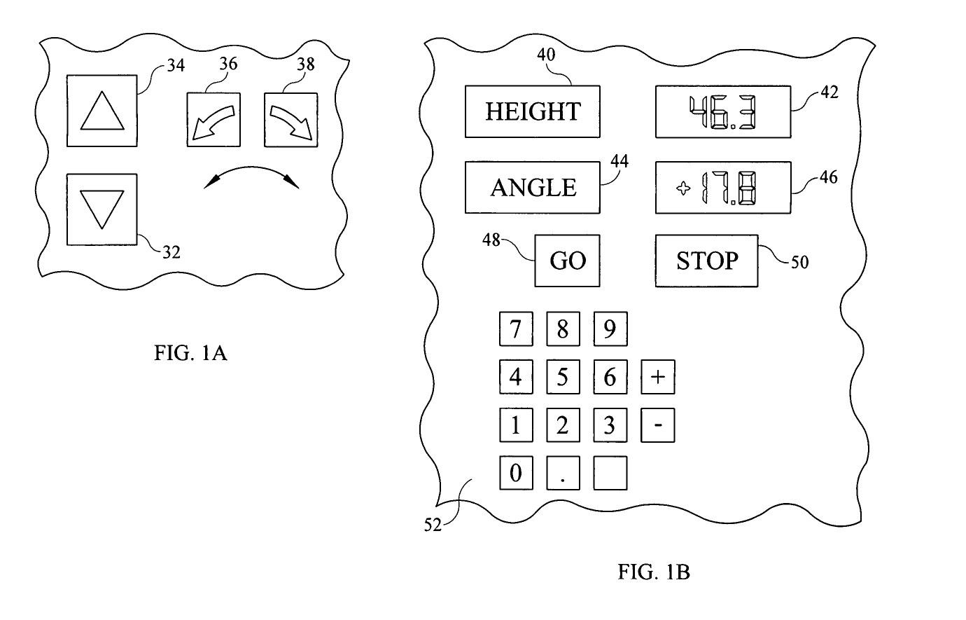

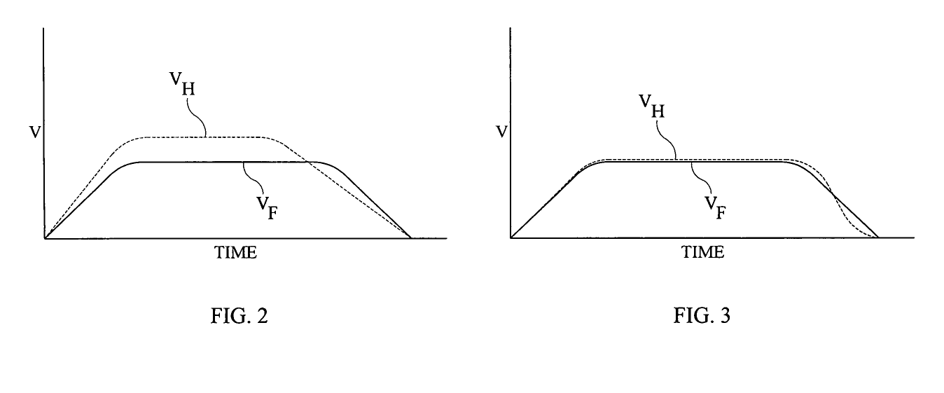

The voltages V_{H}, V_{F} are described above as being different from each other “in general” in recognition of the reality that the voltages, although unequal and independent, may be momentarily numerically equal as depicted in FIG. 2. Similarly, FIG. 3 shows that certain combinations of a prescribed change in elevation and a prescribed change in angular orientation may result in voltages that, although independent of each other, are, by chance, numerically equal for a sustained period of time. However in general most combinations of prescribed elevation change and prescribed angular orientation change will require numerically unequal voltages.

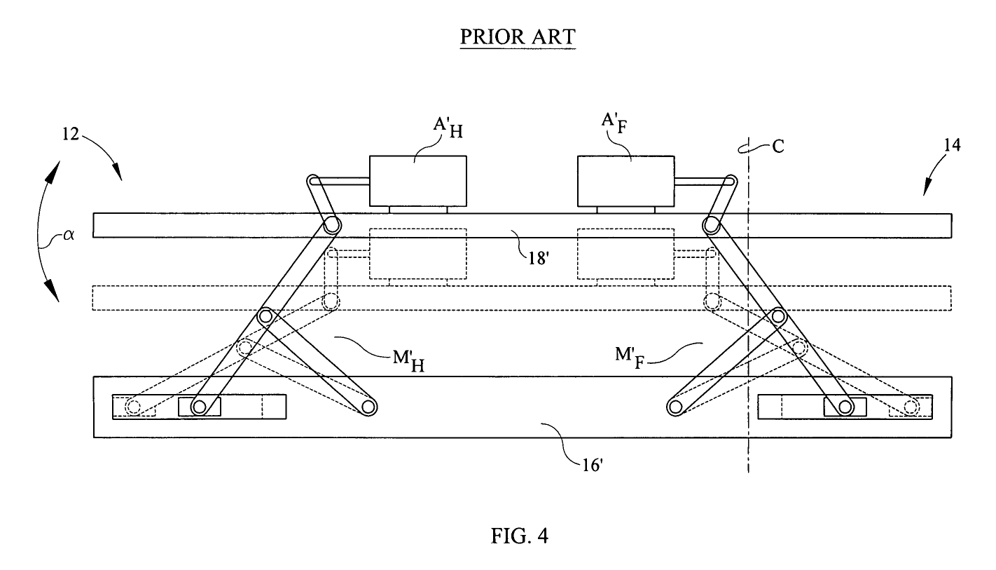

By way of comparison, FIG. 4 illustrates a conventional height adjustable bed which has kinematically similar lift mechanisms. The conventional height adjustable bed includes a base frame 16′, a height adjustable frame 18′ and a pair of lift mechanisms M′_{H} M′_{F}. Each lift mechanism is connected to an actuator A′_{H}, A′_{F}. As illustrated, the mechanisms are symmetrically arranged, however they could also be arranged congruently (e.g. with the foot end mechanism and actuator rotated about axis C). Either way, the mechanisms are kinematically similar, i.e. they each have the same input-output relationship. In operation, equal voltages are applied to each of the motors, which causes substantially equal responses of the actuators and substantially identical responses of the mechanisms thereby raising or lowering the height adjustable frame without affecting its angular orientation α.

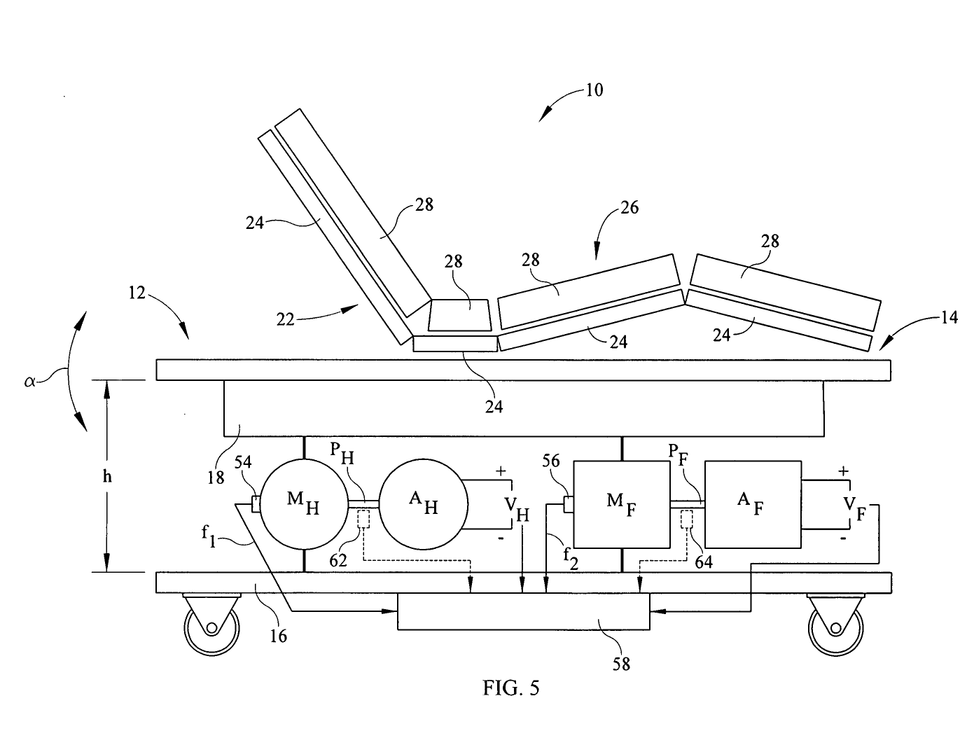

FIG. 5 shows an arrangement similar to that of FIG. 1, including a position feedback sensor 54, 56 associated with each mechanism M_{H}, M_{F} for detecting the state (i.e. height h and angular orientation α) of the height adjustable frame. The sensors convey signals f₁, f₂ to a controller 58, which regulates the voltages V_{H}, V_{F} to achieve the desired change in state (elevation and/or angular orientation) of the height adjustable frame 18. Such an arrangement may be useful to tailor the applied voltages to account for variations in the distribution of weight on the frame. The feedback sensors are each shown as being associated with an element of one of the lift mechanisms M_{H}, M_{F}. However, the sensors could instead be associated with other elements such as the actuators or the height adjustable frame itself. By way of example, sensors 62, 64, shown in phantom, sense the positions of the pistons P_{H}, P_{F} projecting from actuators A_{H}, A_{F}.

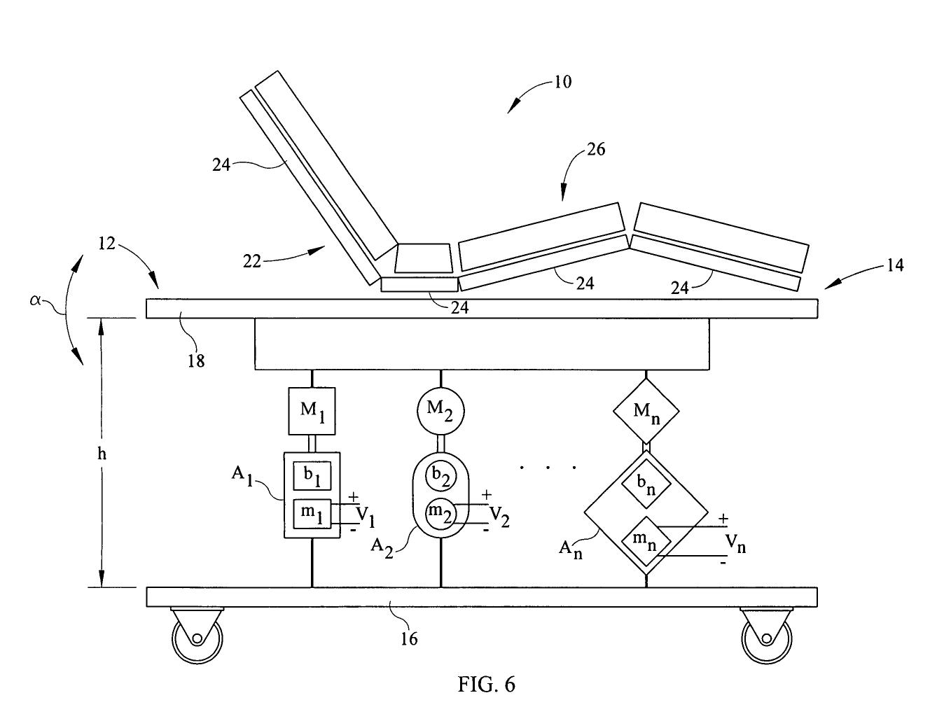

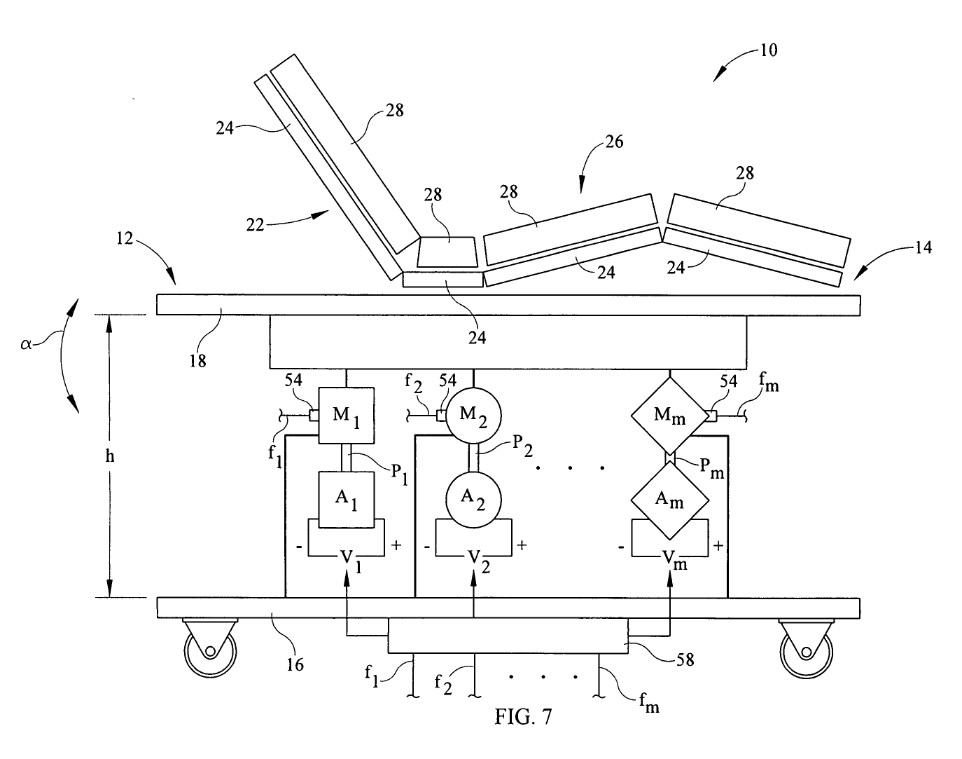

Although FIGS. 1 and 5 depict arrangements with exactly two lift mechanisms, other quantities of lift mechanisms may also be used. For example, FIG. 6 shows a generalization of the system of FIG. 1 employing n lift mechanisms at least one of which is kinematically dissimilar to the other lift mechanisms. FIG. 7 shows a generalization of the arrangement of FIG. 5 employing m lift mechanisms at least one of which is kinematically dissimilar to the other lift mechanism.

Although this disclosure refers to specific embodiments, it will be understood by those skilled in the art that various changes in form and detail may be made without departing from the subject matter set forth in the accompanying claims.

We claim:

1. A lift system for a bed frame, comprising:
multiple lift mechanisms, at least one of which is kinematically dissimilar to the other lift mechanisms;
a dedicated actuator for driving each of the multiple lift mechanisms, each actuator including a motor responsive to a voltage, the voltage applied to each motor being generally unequal and regulated to effect a change in elevation of the frame while concurrently effecting a prescribed change in an angular orientation of the frame.

2. The lift mechanisms of claim 1 wherein the multiple lift mechanisms comprise exactly two lift mechanisms.

3. The lift mechanisms of claim 1 wherein the multiple lift mechanisms are arranged asymmetrically.

4. The lift system of claim 2, wherein one of the two lift mechanisms governs the head end of the frame and the other of the two lift mechanisms governs the foot end of the frame.

5. The lift system of claim 1 wherein the prescribed change in angular orientation is substantially zero.

6. The lift system of claim 1 wherein the voltage is regulated by pulse width modulation.

7. The lift system of claim 1, comprising:
a feedback sensor for detecting a state of the frame; and
a controller for regulating the voltage supplied to each motor in response to the detected state for achieving the elevation and prescribed change of angular orientation.

8. The lift system of claim 7 wherein the voltage is regulated by pulse width modulation.
